(19) United States
(12) Patent Application Publication
(10) Pub. No.: US 2007/0271848 A1
(43) Pub. Date: Nov. 29, 2007

(54) Integrated power window and skylight operating systems

(76) Inventors: Glen Wolf, Owatonna, MN (US); Brian Dallmann, Owatonna, MN (US); Peter Braun, Faribault, MN (US); Thomas Soukup, Owatonna, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/077,967

(22) Filed: Mar. 11, 2005

Related U.S. Application Data
(60) Provisional application No. 60/552,777, filed on Mar. 12, 2004.

(51) Int. Cl. E05F 15/20

(52) U.S. Cl. 49/340; 49/357

(57) ABSTRACT

An operable fenestration operating system for a structure including a window or skylight having a frame, an operable sash and presenting a resistance force opposing opening and closing of the sash. A motorized operator is coupled with the frame and the sash to selectively open and close the sash. The invention includes an operator control unit communicatively connected to the motorized operator. The operator control unit includes a processor, a sensor for sensing the magnitude of the resistance force, a pulse width modulation circuit for supplying electrical power to the motorized operator. The processor varies the torque output of the motorized operator using the pulse width modulation circuit in response to the sensed parameter.

### CLAIM TO PRIORITY

This application claims priority to U.S. Provisional Application Ser. No. 60/552,777 entitled “Improved Integrated Power Window And Skylight Operating Systems” filed Mar. 12, 2004. That Provisional Application is incorporated herein in its entirety by reference.

### FIELD OF THE INVENTION

This invention relates to power window and skylight operating systems.

### BACKGROUND OF THE INVENTION

Motorized window and skylight operator systems have existed in the market for a number of years. In general, these motorized window and skylight operator systems include a motorized operator and an operator control unit. Optionally, these systems may have at least a system control unit. Examples of such operator systems are shown, for example, in U.S. Pat. Nos. 4,136,578; 4,241,541; 4,253,276; 4,266,371; 4,305,228; 4,346,372; 4,497,135; 4,521,993; 4,617,758; 4,823,508; 4,840,075; 4,843,703; 4,845,830; 4,894,902; 4,937,976; 4,938,086; 4,945,678; 5,054,239; 5,152,103; 5,199,216; 5,313,737; 5,493,813; and 5,813,171, all of which are fully incorporated herein by reference.

The above-mentioned references disclose various operator control unit and system control units for mechanically opening and closing windows and skylights. A problem with prior motorized operator systems, however, is that they have typically been difficult to install. Operable fenestration units such as skylights and windows are made in many sizes and configurations, and accordingly, a motorized operator must generally be adjusted for the particular parameters of the individual unit to which it is fit. This involves, for example, determining and setting operator limits corresponding to the fully open and closed positions of the unit. If these limits are not properly determined and set, the operator may continue to run and apply force to the skylight or window after it has reached the full physical limit of its travel, thereby causing damage to the operator, hardware, or unit.

Another installation problem arises in adapting the operator to locally available electrical power. Alternating current power systems within residences and commercial buildings in the United States generally operate at 120 volts and 60 Hz. In other parts of the world, however, 240 volt systems are common, as are 50 Hz frequencies. With prior art power operator systems, it is accordingly necessary to ensure that the proper voltage and frequency is supplied by the building electrical power system to avoid damage to the operator motor and circuitry.

Moreover, in installations where wireless remote control operation is desired, prior art systems have generally provided that control by means of infrared signals. Such signals, however, generally enable only “line-of-sight” communication between the transmitting and receiving devices. As a result, the operator system may not be easily usable with windows or skylights having drapes, blinds, or curtains, or where walls or other obstructions intervene between the transmitter and receiver.

In these days of rising energy prices it is common for great care to be taken in the use of thermostatic control systems for controlling air conditioning. Little development has been directed toward the use of more passive ventilation options under thermostatic control. It would be desirable if a thermostatic control sensed the local temperature where people actually are rather than the temperature at whatever fixed location the thermostatic control happens to be located.

What is still needed in the industry is an easily installable power operator system for windows and skylights that addresses the problems presented by prior art devices.

### SUMMARY OF THE INVENTION

The present invention addresses the need of the industry for an easily installable power operator system for windows and skylights. The present invention also assists in energy savings by permitting a home owner or building operator to take advantage of passive cooling controlled by automation. In addition, the present invention senses the temperature at the location of a remote control that can follow the occupants of the structure wherever they might be so that a desired temperature can be achieved where the people actually are located.

In a preferred embodiment of the invention, a power operator and control system includes means for automatically determining the physical travel limits of a particular window or skylight on which the system is installed and automatically varying the motor torque to prevent damage to the system, hardware, window, or skylight.

In further preferred embodiments of the invention, the operator and control system includes a DC regulated power supply along with means enabling direct application of AC power at any common voltage or frequency. It is thereby unnecessary to ensure that AC power of any specific voltage or frequency is available at the site where the operator system is to be installed, greatly enhancing ease of installation.

Also, other preferred embodiments of the invention may include a wireless remote control system for the operator wherein the signal used for communication is at radio frequency (RF). This enables the remote control system to be used in applications where line-of-sight positioning of transmitter and receiver is not possible, thereby greatly increasing the flexibility of installation and operation of the system.

In another embodiment of the invention, the remote control includes a temperature sensor and a processor. The system is capable of controlling the opening and closing of at least one skylight located in an upper portion of a structure and at least one window located in a lower portion of the structure. The window is preferably located on a shady or cooler side of the structure. Thus the remote control senses a temperature at its location and, if that temperature is higher than a preset value, opens the window and the skylight to facilitate passive movement of warm air out through the skylight and cooler air in through the window by convention. The remote control located thermostat may also eliminate the need for a hard wired thermostat, thereby reducing system installation time and cost. Further, the remote control may be made to simultaneously operate any number and combination of windows and skylights as may be desired.

Other features and advantages of the invention will be apparent from the following description of the preferred embodiments thereof, and from the claims.

### BRIEF DESCRIPTION OF THE DRAWINGS

FIG. 1 is a perspective view of an embodiment of a motorized window and skylight operating system according to the invention;

FIG. 2 is a perspective view of another embodiment of a motorized window and skylight operating system according to the invention;

FIG. 3 is a perspective view of a first embodiment of an operator control unit with wall switch control;

FIG. 4 is a perspective view of a second embodiment of an operator control unit with wall switch control;

FIG. 5 is a perspective view of yet another embodiment of the operator control unit with wall switch control;

FIG. 6 is a partial perspective view of a motorized operator system according to the present invention coupled with a window;

FIG. 7 is a perspective view of the operator control unit and motorized operator having a chain drive; and

FIG. 8 is block diagram of a portion of several components of the present invention.

### DETAILED DESCRIPTION OF THE INVENTION

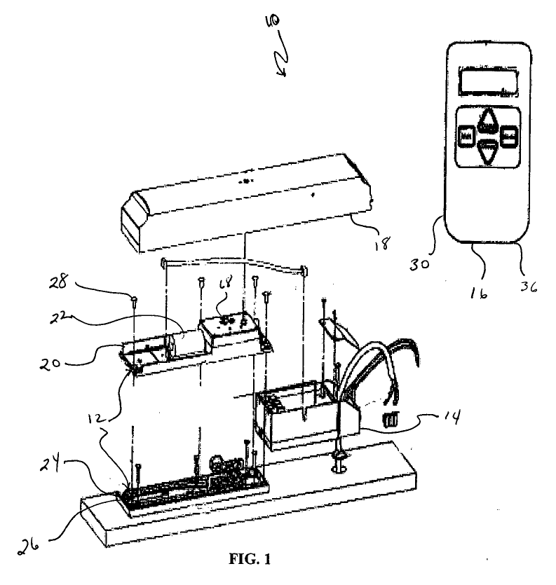

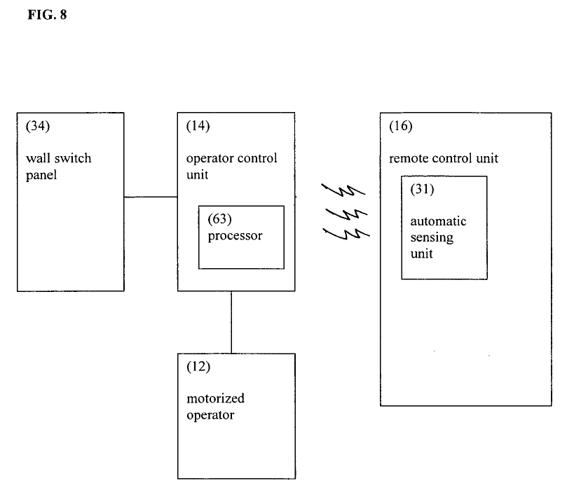

FIGS. 1 and 8 depict a motorized window and skylight operator system 10 according to the present invention. The motorized window and skylight operator system 10 generally includes a motorized operator 12 and an operator control unit 14. Optionally, the system 10 may include a remote control unit 16 for wirelessly controlling the system from a remote location. In the depicted embodiment, the motorized operator 12 generally includes an operator cover 18, an upper portion 20 having a motor 22, and a lower portion 24 having a chain drive 26. Other drives may also be used as will be recognized by those skilled on the art. The upper portion 20 may be coupled with the lower portion 24 by fasteners 28 such as screws. The operation and further details of the motorized operator 12 are disclosed in U.S. Pat. Nos. 4,521,993 and 4,945,678, both previously incorporated herein by reference.

In the context of this application the term fenestration is to be construed to include but not be limited to openable windows and openable skylights.

The operator control unit 14 may be controlled by any suitable means including wireless remote control 30, automatic sensing units 31, or a wired switch 32 which may be conveniently mounted in a wall switch panel 34. The operator control unit 14 enables opening, closing or stopping movement of the window or skylight connected with the motorized operator at any intermediate point between the fully open and fully closed position of the window or skylight.

Automatic sensing units 31 may include sensors for sensing incremental movement of the window, the presence of a substance (e.g., carbon dioxide and water), or physical conditions (e.g., temperature and relative humidity) in an area. These sensing units may also include means for transmitting control signals to the operator control unit if particular movements occur or conditions arise. Moreover, the sensing units may be located either adjacent or remote from the operator control unit to effect automatic opening or closing a window upon the occurrence of preselected conditions at the sensor.

Some non-limiting examples of these sensing units include sensors for monitoring temperature, heat, carbon dioxide, rain, fire, smoke, and moisture sensors. In one example, a heat or smoke detector is used to detect the presence of fire and smoke and to signal opening or closing the window or skylight as desired to control smoke ventilation. In another example, a thermostat is used to effect automatic opening or closing a window or a skylight when a predetermined temperature is reached at the thermostat. This allows the use of passive cooling under a thermostatically controlled system.

Moreover, a rain sensor may be used to effect automatic opening or closing a window or a skylight upon the detection of rain. The rain sensor may have gold plated contacts and/or alternating current (AC) sensing. Gold plated contacts reduce corrosion of rain sensors by rain, particularly rain with acidic contamination. Alternating current sensing may provide a more reliable method of detecting rain than direct current sensing as is used in many prior art sensing systems.

If desired, the system may be controlled with any suitable wireless remote control 30 including apparatus using infra-red (IR), radio frequency (RF), sound, microwave, electrical, or magnetic signals. In one preferred embodiment, a handheld unit 36 includes an RF transmitter to send commands to a receiver in the operator control unit.

RF signaling eliminates the need for “line of sight” proximity of the system transmitter and receiver as in prior IR signaling systems. Further, RF signaling eliminates the problem of interference by direct sunlight encountered with IR systems. Third, the RF systems work in multi-directional orientation so as to avoid the need to point the transmitter directly to the receiver. The RF transmitter may use a “rolling code” system as is known in the art to help safe guard against frequency capture. The transmitter communicates the key code, information on the command type (such as open, close, window, and blind), and the unit code (such as 1-9 and “all”). This enables the remote to control an infinite number of motors, grouped into 1 of 9 different unit codes or groups, and control them individually or all at once. The communication may be made in a “burst” or “packet” transmission which contains all the information on the command. Moreover, the “packet” information may be sent twice to ensure accuracy and eliminate false signals. Although any suitable frequency or modulation method may be used, in one currently preferred embodiment the transmission frequency is 433 MHz AM.

Each operator control unit 14 can be connected with and control multiple motorized operators 12, enabling simultaneous control of multiple windows and/or skylights. For example, a thermostat connected with a single operator control unit 14 may open and close several windows and skylights simultaneously to maintain a more comfortable interior temperature and take advantage of the “chimney cooling effect” to reduce energy consumption. Taking advantage of passive, convective cooling can realize substantial energy savings.

In some embodiments, the operator control unit 14 may include a DC regulated power supply that converts AC power supplied at any common voltage and frequency to a constant and regulated DC output, thereby improving operator motor 22 performance by reducing speed and torque fluctuations caused by fluctuations in the AC power supply. The power supply enables direct application of varying worldwide power inputs to avoid the requirement for separate transformers and power supplies or re-wiring of transformers to compensate for changing voltage requirements.

In some embodiments, the operator control unit 14 includes means for controlling the torque of motorized operator 12 through software control of output current to motorized operator 12. The torque controlling means adjusts to provide the necessary torque to drive the system and allows current settings to be set to specific parameters for different operator systems 10 through software control determined by appropriate switch settings on a control board. This allows the creation of a custom profile for each operator system. The torque controlling means allows the operator torque to increase and decrease at different stages of operation to avoid damage to motorized operator 12 and to the controlled windows or skylights.

The operator control unit 14 may include means for resetting the system with a wall switch panel 34 controlled by a remote control 30; means for changing switch settings on the control board; and means for powering down and back up. The means provide various flexible options to reset the system and to control the system easily.

In further embodiments, the operator control unit 14 includes other components or routines, such as main control loop, initialize window routine, read line voltage and adjusts for changes routine, drive motor routine, timer interrupt service routine, and read inputs and determine a goal positions routine, as described in U.S. Pat. Nos. 4,933,613; 5,004,961; 5,285,137; 5,355,059; and 5,449,987, all of which are fully incorporated herein by reference.

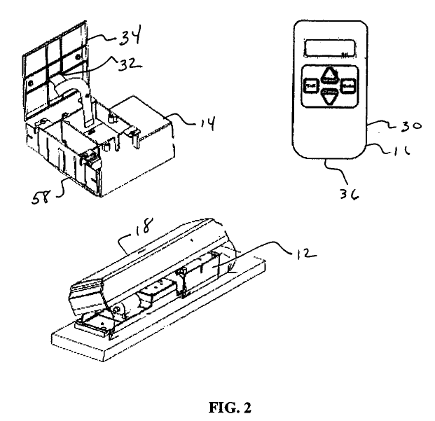

FIG. 2 depicts a motorized window and skylight operating system according to the present invention. The system generally includes a motorized operator 12 with a chain drive or gear drive, a remote control 30, and an operator control unit 14. The chain drive motorized operator 12 is generally used with heavy skylights, while the gear drive is generally used for windows and lighter weight skylights.

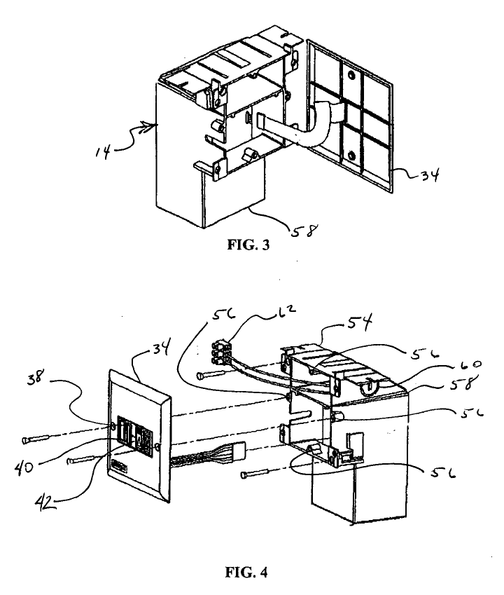

FIGS. 3-5 depict three embodiments of the operator control unit 14 suitable for the motorized window and skylight operating systems according to the invention. In the depicted embodiments, the operator control unit 14 is wired to a wall switch panel 34. The wall switch panel 34 may include a membrane switch 38 which makes wall switch panel 34 easy to clean and unobtrusive. A cut groove 40 may be incorporated around the membrane switch to allow for placing and cutting of wall paper over the face of the entire wall switch panel 34. This cut groove 40 also serves as a paint barrier to prevent paint from getting on the membrane switch when the face of the wall switch panel is being painted. An optional bi-color light emitting diode (LED) 42 may be incorporated on the wall switch panel 34 for providing feedback to the installer or user on the operating status and fault codes of the motor 22 or control board.

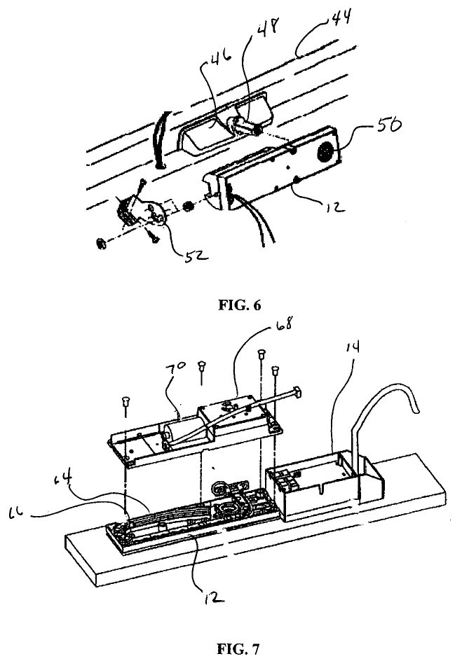

FIG. 6 depicts the motorized operator system 10 of the present invention engaged with a window 44 having a rotary crank type manual operator mechanism 46 as is commonly known in the art. The motorized operator 12 couples to rotatable shaft 48 of the window operator mechanism 46 using a spline adaptor 50 as depicted. The motorized operator 12 is attached to the frame of the window 44 with a bracket 52.

In some embodiments, the operator control unit 14 itself may be installed in a wall with the operator control unit 14 recessed substantially inside the wall such that the only visible feature is a low profile wall switch panel 34 that matches a standard size (4.5″×4.5″) 2-gang electrical box face plate. In other embodiments, the system may incorporate easy break-off flanges 54 that allows common operator control unit 14 to be installed in both new construction projects and in remodeling projects.

The operator control unit 14 may be installed in 0, 90, 180 and 270 degree orientations while the mating wall switch panel 34 can remain in the normal viewing angle. This provides the end user more installation options. This may be accomplished through the use of two sets of mounting holes 52 in the box 58 to mount the wall switch panel 34 and the use and placement of two knock-outs 60 for high-voltage input wiring. The two sets of mounting holes 52 are then oriented orthogonal to each other.

In some embodiments, common screws or nails are used to mount operator control unit 14 into the wall. High-voltage AC input wiring can be routed into the box 58 on two opposite sides via removable knock-outs 60 to provide for ease of assembly. In some embodiments, a strain relief bushing of push-in design may be provided to allow Romex style nonmetallic sheathed wiring to be pushed into box 58 without the need to assemble and tighten any fasteners to provide clamping force. The wiring access hole left when knock outs 60 are removed may be designed to accept standard ½″Romex or conduit fittings to meet the strain relief requirement.

A terminal block 62 including an easy snap-on feature may be provided to allow easy and secure hook-up of supply wiring and to fasten the terminal block 62 to the electronic box 58 sidewalls without requiring any additional fasteners.

In some embodiments, motor 22 in the motorized operator 12 is a high reduction gear motor with an interchangeable drive bushing which fits onto the crank shaft 48 of manual window or skylight operators 46. A 24 volt DC motor 22 is used to power motorized operator 12.

Motor 22 is controlled digitally through a pulse width modulation (PWM) control circuit. The control circuit monitors current drawn at the motor to sense the position of the window or the skylight. When the window or the skylight reaches a pre-determined stall position in either open or closed orientations, the motor current spikes to the stall current limit allowed by the control. This serves to protect the motor 22 from over current burn-out and establishes an end point location for the control program.

The operator control unit 14 may include a digital processor 63 capable of running a control program. The control program may include an initialization routine to prevent the motorized operator 12 from reaching the full open end point of the hardware, since this type of stall load severely shortens the life of the hardware. The initialization routine first determines parameters related to the end points of the hardware (stall in open and close) and the time between open and closed positions. The end point parameters are stored in a non-volatile memory connected with the digital processor 63. In one embodiment of the invention the program stops the fenestration at 75% of full open on the first command to “open.” Each successive “open” command opens the fenestration another 5% until the fully open position is reached. These stop points may be estimated in comparison with the motor 22 rotation count between full open and full closed stall conditions.

The control program may also provide a safety or obstruction detection and avoidance feature. This feature enables the window or the skylight to sense the presence of an obstruction during all but the last 20% of the closed position, preferably the last 10%, more preferably the last 5%. This is accomplished by using a lower amperage cutoff point for the motor.

Further safety may be provided through the use of a screen interlock. The screen interlock is a device fastened to the screen of the motorized window. The screen interlock interrupts the power to the drive motor 22 when the screen is removed from the window, thereby preventing the insertion of fingers of other body parts into the fenestration where they might be caught in the closing process. Thus the screen acts as a safety barrier.

In some embodiments, the operator control unit 14 includes a six switch DIP on which the user sets specific operating parameters by placing various switches on or off. The positions of switches one and two are used to determine the type of motor to be controlled (motors for window, light skylight, or heavy skylight) or whether the unit is a leader or follower (for skylight synchronous operation). Switch three is used to set the operating direction of the window motor (clockwise vs. counterclockwise). Switch four is used to signal the control board that motorized blinds are connected to. Switches five and six are used to determine the number of locks (such as one, two and none) to drive on a motorized casement window or to tell the control board which synchronous motor positions are for skylight synchronous operation.

In some embodiments, the control circuit monitors a number of input points and drives the motor accordingly. The first and primary input to the control circuit may be via a wall switch panel 34 connected directly to the control board. The second input may be via a radio frequency (RF) receiver, which is responsive to a remote control as previously described. The third input may be via a high priority input (HPI), which is a set of three pair control loops.

The first loop of the HPI is the open and hold or smoke vent port. This port enables the direct connection of a pair of contacts to open the window or the skylight and lock out the wall switch panel 34 control in the case of fire detected by a fire or smoke sensor connected to the port. The second port of the HPI is the close and hold or security port. This second port enables the direct connection of a pair of contacts to close and lock out the vent when it is controlled by a home security system. The third HPI port works in conjunction with the security port by providing a positive (dry contact) feedback that the fenestration is in the fully closed position. The third port enables the fenestration to signal the security system that the fenestration is closed prior to arming the security system monitoring command.

An additional input port may be built into the control circuit for connection to a rain sensor (not shown), which will close the window or the skylight upon sensing condensing moisture or raindrops on its contact surface.

Further, the control circuit may provide an interface for 12 volt DC operated power blinds. The blinds connected to the interface may be controlled via a hand held remote control or through the wall switch panel.

FIG. 7 depicts a perspective view of an operator control unit 14 engaging with a motorized operator 12 having a chain drive 26 for opening and closing windows and skylights. The motorized operator 12 is in a close proximity with and connected through a cable to operator control unit 14. The motorized operator 12 includes a lower portion having a chain drive 26 and an upper portion having a DC motor 22. The operator control unit 14 includes a control board (not shown). In some embodiments, the control board (not shown) enables asynchronous control of multiple skylights using a single system control unit, such as a remote control 30, a membrane switch 38, high priority inputs (HPI), or a rain sensor. A command signal from either the remote control 30, the membrane switch 38, the HPI, or the rain sensor to one primary skylight receiver board is communicated through hardwiring from a RS485 bus to a plurality of independent, secondary skylights downstream of the primary skylight. The secondary skylights execute the command with no feedback to the master. A bi-color light emitting diode (LED) 42, visible through the unit cover, may be optionally incorporated on the control board (not shown). LED 42 provides feedback to the installer or the user on the operating status and fault codes of the motor or control board.

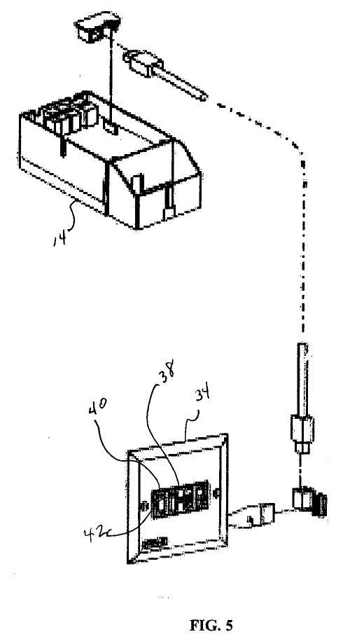

A wall switch panel 34 may be connected to the control board through a RJ45 cable and connector 43, such as those depicted in FIG. 5, to provide additional control input options to the user. Optionally, a standard 110VAC single pole/double throw (momentary center “off”) switch (not shown) may be used to control the unit's opening, closing, or resetting without either a wall switch panel 34 or a remote control 30. The control board may include a RS485 input to provide for home automation control system interface. The operator control unit 14 may include locating tabs on the base of the operator control unit 14 to align the box 58 to the operator control unit 14 during installation, thereby preventing misalignment and simplifying installation.

In some skylight embodiments, snap features are provided to fix in place temporarily the cover 18 for the motorized operator 12 or the operator control unit 14 during installation until the more permanent mounting fasteners 28 such as screws can be installed. This prevents the cover 18 from “falling” from the unit and possibly being damaged or creating a safety hazard.

The chain drive 26 in the motorized operator 12 includes a heavy lift chain 64 that is capable of lifting heavy skylight lids. The chain 64 is driven by a high reduction gear drive 68 coupled to a 24 volt DC motor 22. Again, the motor 22 may be controlled digitally through a pulse width modulation control circuit. The digital control system may also include simultaneous monitoring of the motor 22 speed and rotations through a Hall effect pickup and a magnet attached directly to the motor 22 shaft. The control circuit monitors the current drawn at the motor 22 to sense skylight lid position.

When the skylight lid reaches a pre-determined stall position in either open or closed orientation, the motor 22 current spikes to the stall current limit allowed by the control. This serves to protect the motor 22 from over current burnout and establishes the end point position for the control program. The control program then runs through an initialization routine to determine parameters related to the end points (stall in open and close) and the number of motor 22 rotations between open and closed positions. These parameters are stored in a non-volatile memory and used to control the skylights position depending upon the input commands given to the control circuit. The control program is designed to prevent the motorized operator 12 from reaching the full open end point of the hardware, since this type of stall load severely shortens the life of the hardware. In some embodiments, the unit may open to 90% of full open position on skylights. These stop points may be estimated in comparison with the motor 22 rotation count between full open and full closed stall conditions.

Again, an additional input port may be built into the control circuit for connection to a rain sensor. The additional input port enables a signal to close the window or the skylight upon sensing condensing moisture or rain drops on its contact surface. Optionally, a wall switch panel 34 may be used to input commands to the operator control unit 14 connected through a RJ45 cable and a cable connector on each end of the cable 43.

To lift heavy skylights, multiple motors, either in one single motorized operator 12 or in a multiple motorized operators 12, may be used together. The control circuit for these multiple motors 22 may include a two-way communication link via a pair of four wire connection ports. These ports enable the motors 22 to communicate the relative chain position and motor 22 revolution counts to insure that the skylight lids are moved by the motors 22 in unison. The motor 22 may also be controlled digitally through a pulse width modulation control circuit, which may also simultaneously monitor the motor 22 speed and rotations by using a Hall effect pickup and a magnet attached directly to the motor 22 shaft. Without feedback produced by the Hall effect pickup, the motors 22 could run at different speeds, and result in the chains running “out of time.” In some instances, misalignment of the chains by more than six millimeters total between the motors may result in damage to the skylight or even breakage of the glass.

The present invention may be embodied in other specific forms without departing from the central attributes thereof, therefore, the illustrated embodiments should be considered in all respects as illustrative and not restrictive, reference being made to the appended claims rather than the foregoing description to indicate the scope of the invention.

What is claimed is:

1. A power operator system for opening and closing an operable fenestration unit, the operable fenestration unit including a frame, an operable sash coupled with the frame, and presenting a resistance force opposing opening and closing of the sash, the system comprising:
at least one motorized operator operably couplable with the frame and the sash of the operable fenestration unit to selectively open and close the sash, the motorized operator including at least one electric motor; and
an operator control unit communicatively connected to the motorized operator, the operator control unit comprising:
means for sensing a parameter related to the magnitude of the resistance force; and,
means for controlling the torque output of the motor in response to the parameter.

2. The system of claim 1, wherein the operator control unit comprises a processor and a pulse width modulation circuit communicatively connected with the processor.

3. The system of claim 1, wherein the parameter related to the magnitude of the resistance force is the magnitude of current drawn by the motor.

4. The system of claim 1, wherein the operator control unit further comprises means for determining the position of the sash relative to the frame.

5. The system of claim 4, wherein the means for determining the position of the sash relative to the frame comprises a Hall effect sensor.

6. The system of claim 4, wherein the operator control unit further comprises:
(i) a processor;
(i) a control algorithm associated with the processor and including an initialization routine for determining a parameter related to each of a pre-determined full open position and a pre-determined full closed position of the sash; and
(ii) a non-volatile memory associated with the processor for storing the full open position parameter and the full closed position parameter.

7. The system of claim 1, further comprising means for controlling the operation of the power operator system from a remote location.

8. The system of claim 7, wherein the means for controlling the operation of the power operator system from a remote location comprises a radio frequency transmitter for sending control signals and a radio frequency receiver communicatively connected with the operator control unit for receiving and communicating the control signals to the operator control unit.

9. The system of claim 1, further comprising means for sensing a parameter related to an environmental condition and means for controlling the operator of the power operator system in response to the parameter.

10. The system of claim 9, wherein the means for sensing a parameter related to an environmental condition comprises a smoke detector communicatively connected with the operator control unit.

11. The system of claim 9, wherein the means for sensing a parameter related to an environmental condition comprises a rain sensor communicatively connected with the operator control unit.

12. The system of claim 1, further comprising a plurality of motorized operators each adapted to be operably couplable with a separate operable fenestration unit to open and close the sash of the unit, each of the plurality of motorized operators communicatively connected with the operator control unit so as to enable simultaneous operation and control of the plurality of motorized operators.

13. A method of opening and closing an operable fenestration unit using a power operator system, the operable fenestration unit including a frame, an operable sash coupled with the frame, and presenting a resistance force opposing opening and closing of the sash, the system comprising at least one motorized operator with a motor operably coupled with the frame and the sash of the operable fenestration unit to selectively open and close the sash, and an operator control unit communicatively connected to the motorized operator, the method comprising steps of:
sensing a parameter related to the magnitude of the resistance force; and,
controlling the torque output of the motor in response to the parameter using the operator control unit.

14. The method of claim 13, wherein the operator control unit includes a non-volatile memory device, and wherein the method further comprises the steps of determining a parameter related to each of a pre-determined full open position and a pre-determined full closed position of the sash and storing the parameters in the memory device.

15. An operable fenestration system for a structure comprising:
at least one operable fenestration unit including a frame, an operable sash coupled with the frame, and presenting a resistance force opposing opening and closing of the sash;
at least one motorized operator operably coupled with the frame and the sash of the at least one operable fenestration unit to selectively open and close the sash, the motorized operator including at least one electric motor; and
an operator control unit communicatively connected to the motorized operator, the operator control unit comprising:
a processor;
a sensor communicatively coupled with the processor for sensing a parameter related to the magnitude of the resistance force; and;
a pulse width modulation circuit for supplying electrical power to the motorized operator and communicatively connected with the processor, wherein the processor varies the torque output of the motorized operator using the pulse width modulation circuit in response to the sensed parameter.

16. The system of claim 15, wherein the parameter related to the magnitude of the resistance force is the magnitude of current drawn by the motor.

17. The system of claim 15, wherein the operator control unit further comprises means for determining the position of the sash relative to the frame.

18. The system of claim 17, wherein the means for determining the position of the sash relative to the frame comprises a Hall effect sensor.

19. The system of claim 17, wherein the operator control unit further comprises:
(i) a control algorithm associated with the processor and including an initialization routine for determining a parameter related to each of a pre-determined full open position and a pre-determined full closed position of the sash; and
(ii) a non-volatile memory associated with the processor for storing the full open position parameter and the full closed position parameter.

20. The system of claim 15, further comprising means for controlling the operation of the power operator system from a remote location.

21. The system of claim 20, wherein the means for controlling the operation of the power operator system from a remote location comprises a radio frequency transmitter for sending control signals and a radio frequency receiver communicatively connected with the operator control unit for receiving and communicating the control signals to the operator control unit.

22. The system of claim 15, further comprising means for sensing a parameter related to an environmental condition and means for controlling the operator of the power operator system in response to the parameter.

23. The system of claim 22, wherein the means for sensing a parameter related to an environmental condition comprises a smoke detector communicatively connected with the operator control unit.

24. The system of claim 22, wherein the means for sensing a parameter related to an environmental condition comprises a rain sensor communicatively connected with the operator control unit.

25. The system of claim 15, further comprising a plurality of motorized operators each operably coupled with the frame and sash of a separate one of a plurality of operable fenestration units, each of the plurality of motorized operators communicatively connected with the operator control unit so as to enable simultaneous operation and control of the plurality of motorized operators.

26. An operable fenestration system for a structure comprising:
an upper operable fenestration unit including a first frame, a first operable sash coupled with the first frame, and being located proximal an upper portion of the structure;
a lower operable fenestration unit including a second frame, a second operable sash coupled with the second frame, and being located proximal a lower portion of the structure;
a first and a second motorized operator operably coupled with the respective frame and the sash of the upper and lower operable fenestration units to selectively open and close the sashes, the first and second motorized operators including at least one electric motor; and
an operator control unit communicatively connected to the motorized operator, the operator control unit comprising:
a processor;
a sensor communicatively coupled with the processor for sensing an environmental parameter; and;
wherein the processor commands the operation of the first and second motorized operators in response to the sensed environmental parameter.

27. The operable fenestration system of claim 26, wherein the sensed environmental parameter is ambient temperature within the structure and the processor commands opening of the sashes in response to a rise in the temperature above a selected value whereby convective cooling of the structure is facilitated.

28. The operable fenestration system of claim 26, wherein the sensed environmental parameter is ambient temperature within the structure and the processor commands closing of the sashes in response to a reduction in the temperature below a selected value whereby convective cooling of the structure is terminated.

29. The operable fenestration system of claim 26, wherein the sensor is located in a handholdable remote control unit.

30. The operable fenestration system of claim 27, further comprising a sensor located outside the structure, the sensor sensing outside ambient temperature and the processor comparing the outside ambient temperature with the ambient temperature within the structure and commanding opening of the sashes only if the outside ambient temperature is lower than the ambient temperature within the structure.
